(19) United States
(12) Patent Application Publication
(10) Pub. No.: US 2026/0246105 A1
(43) Pub. Date: Aug. 20, 2026

(54) BATTERY PACK

(71) Applicant: SAMSUNG SDI CO., LTD., Yongin-si (KR)

(72) Inventors: Sang Hun PARK, Yongin-si (KR); Dong Wook LEE, Yongin-si (KR)

(21) Appl. No.: 19/392,307

(22) Filed: Nov. 18, 2025

(30) Foreign Application Priority Data
Feb. 18, 2025 (KR) 10-2025-0020885

(51) Int. Cl. H01M 50/533; H01M 50/474; H01M 50/483; H01M 50/534; H01M 50/536; H01M 50/574

(52) U.S. Cl. CPC H01M 50/533; H01M 50/474; H01M 50/483; H01M 50/534; H01M 50/536; H01M 50/574

(57) ABSTRACT

A battery pack includes protection circuit module electrically connected to the battery, and a connection part where an electrode tab of the battery and a connection pad of the protection circuit module are connected via a solder. An insulating film in the connection part has an opening exposing a part of the connection pad to the electrode tab, with the insulating film being bonded to an upper surface of the connection pad. The electrode tab may be disposed on an upper side of the insulating film and may be joined to the connection pad via the solder, which extends through the opening and contacts the connection pad and the electrode tab.

### CROSS-REFERENCE TO RELATED APPLICATION

The present application claims priority to and the benefit of Korean Patent Application No. 10-2025-0020885, filed on Feb. 18, 2025, in the Korean Intellectual Property Office, the entire disclosure of which is incorporated herein by reference.

### BACKGROUND

### 1. Field of the Disclosure

The present disclosure relates to a battery pack.

### 2. Discussion of Related Art

Secondary batteries are batteries that can be charged and discharged, unlike primary batteries, which cannot be recharged. Low-capacity secondary batteries are used in portable small electronic devices such as smartphones, feature phones, laptop computers, digital cameras, and camcorders, while high-capacity secondary batteries are widely used as power sources for motor driving in hybrid vehicles, electric vehicles, and the like and/or used as batteries for power storage or the like. These secondary batteries include an electrode(s) including a positive electrode and/or a negative electrode, an electrode assembly including the electrode(s), a case accommodating the electrode assembly, an electrode terminal connected to the electrode assembly, and the like.

As technology advances, high-capacity secondary batteries are required. Accordingly, a plurality of secondary batteries may be used by being electrically connected. For example, the secondary batteries can be applied to electronic devices in the form of a secondary battery module including a plurality of secondary batteries and/or a secondary battery pack including a plurality of secondary battery modules. In some embodiments, the secondary battery pack is formed by a plurality of secondary batteries. In this case, the electronic devices are electronic devices requiring high output and/or high capacity and include, for example, electric vehicles and the like.

A battery pack including one or more batteries has a protection circuit module (PCM) connected to the batteries to stably supply current to an external device. The protection circuit module may form a high current path such as a charge/discharge current of the battery and/or sense a signal related to state information of the battery to control the operation of the battery. To this end, the battery pack includes a connection part electrically connecting an electrode tab (which is plate shaped) of the battery and a connection pad of the protection circuit module, and the electrode tab and the connection pad are generally joined using solder while facing each other.

The above-described information disclosed in the background technology of this invention is only intended to improve understanding of the background of the present invention and therefore may include information that does not constitute related art.

### SUMMARY OF THE DISCLOSURE

The present disclosure is directed to providing a battery pack capable of improving bonding strength between an electrode tab of a battery and a connection pad of a protection circuit module and capable of improving space utilization.

However, technical problems to be solved by the present disclosure are not limited to the problems described above, and other problems solved by the present disclosure that are not mentioned above can be clearly understood by those skilled in the art from the description of the invention found below.

A battery pack according to some embodiments of the present disclosure may include a battery including an electrode tab, a protection circuit module electrically connected to the battery, the protection circuit including a connection pad, and a connection part where the electrode tab and the connection pad of the protection circuit module may be connected via a solder. An insulating film in the connection part includes an opening exposing a part of the connection pad to the electrode tab, with the connection part being bonded to an upper surface of the connection pad. The electrode tab may be disposed on an upper side of the insulating film and may be joined to the connection pad via the solder, which extends through the opening and contacts the connection pad and the electrode tab.

In some embodiments, a part of the solder extends through a contact interface between the electrode tab and the connection pad.

In some embodiments, a penetration groove may be formed on a side surface of the electrode tab, and wherein the solder covers the penetration groove.

In some embodiments, the penetration groove may have a semicircular shape.

In some embodiments, a penetration hole may be formed through the electrode tab, and wherein the solder covers the penetration hole.

In some embodiments, the penetration hole may have a circular shape.

In some embodiments, the connection part may further include a metal pattern between the connection pad and the insulating film, the connection pad being at least a partially exposed via empty spaces between metal portions of the metal pattern, and wherein the electrode tab may be joined with the connection pad via the solder while the insulating film and the connection pad may be in contact with the metal pattern.

In some embodiments, the metal pattern may be a line-shaped pattern offset from the penetration groove and extending in a width direction of the electrode tab.

In some embodiments, the metal pattern may be formed of a same material as the connection pad.

In some embodiments, the connection part may further include an insulating sheet disposed under the connection pad.

In some embodiments, the insulating sheet may be a mica sheet.

In some embodiments, the connection pad may be formed by a material including copper or nickel.

In some embodiments, the insulating film may be formed by a material including polyimide.

A battery pack according to some embodiments of the present disclosure may include a battery having an electrode tab protruding outside of a case, a protection circuit module including a connection pad, the protection circuit being electrically connected to the battery by the connection pad joined with the electrode tab , and an insulating film disposed between the electrode tab and the connection pad, the insulating film including an opening exposing a part of the connection pad to the electrode tab. A solder extends through the opening and contacts the electrode tab and the connection pad so that the solder joins the electrode tab and the connection pad.

In some embodiments, a part of the solder extends through a contact interface between the electrode tab and the connection pad.

In some embodiments, a penetration groove may be formed on a side surface of the electrode tab, and wherein the solder covers the penetration groove.

In some embodiments, a penetration hole may be formed through the electrode tab, and wherein the solder covers the penetration hole.

In some embodiments, the battery pack may further include a metal pattern between the connection pad and the insulating film, the connection pad being at least partially exposed via the opening, and wherein the electrode tab may be joined with the connection pad via the solder while the insulating film and the connection pad may be in contact with the metal pattern.

In some embodiments, a penetration groove may be formed on a side surface of the electrode tab, and wherein the metal pattern may be a line-shaped pattern offset from the penetration groove and extending in a width direction of the electrode tab.

In some embodiments, the battery pack may further include an insulating sheet disposed under the connection pad.

### BRIEF DESCRIPTION OF THE DRAWINGS

The following drawings illustrate exemplary embodiments of the present disclosure and show some aspects and features of the present disclosure. The present disclosure should not be construed as being limited to the drawings.

FIG. 1 is a perspective view schematically illustrating a configuration of a battery pack according to some embodiments of the present disclosure.

FIG. 2 is an exploded perspective view schematically illustrating a configuration of a battery of FIG. 1 according to some embodiments of the present disclosure.

FIG. 3 is an exploded perspective view schematically illustrating a configuration of a connection part of a battery pack according to some embodiments of the present disclosure.

FIG. 4 is a plan view of the connection part of FIG. 3 in a combined state according to some embodiments of the present disclosure.

FIG. 5 is a cross-sectional view along line V-V in FIG. 4 according to some embodiments of the present disclosure.

FIG. 6 is an exploded perspective view schematically illustrating a configuration of a connection part according to some embodiments of the present disclosure.

FIG. 7 is a plan view of the connection part of FIG. 6 in a combined state according to some embodiments of the present disclosure.

FIG. 8 is a cross-sectional view along line VIII-VIII in FIG. 7 according to some embodiments of the present disclosure.

FIG. 9 is a cross-sectional view along line IX-IX in FIG. 7 according to some embodiments of the present disclosure.

### DETAILED DESCRIPTION OF EXEMPLARY EMBODIMENTS

Hereinafter, exemplary embodiments of the present invention will be described in detail with reference to the attached drawings. Prior to this, terms or words used in this specification and claims should not be interpreted limited to ordinary or dictionary meanings and should be interpreted as meanings and concepts consistent with the technical idea of this invention based on the principle that the inventor can properly define the concept of the term in order to describe his or her invention in the best way. Accordingly, it is to be understood that the embodiments described herein, and configurations illustrated in the drawings are only some exemplary embodiments of the invention and do not represent all of the technical ideas of the invention and that there may be various equivalents and modifications that may replace the configurations illustrated at the time of filing.

Furthermore, when used herein, the terms “comprise or include” and/or “comprising or including” specify the presence of the mentioned shapes, numbers, steps, operations, members, elements, and/or groups thereof and are not intended to exclude the presence or addition of one or more other shapes, numbers, operations, members, elements, and/or groups thereof.

In addition, to aid understanding of the invention, the accompanying drawings are not drawn to scale and the dimensions of some components may be exaggerated. In addition, the same reference numbers may be assigned to the same components in different embodiments.

The statement that two objects for comparison are ‘equal’ means ‘substantially the same.’ Therefore, substantially the same may include deviations that are considered low in the art, for example, deviations of less than 5%. Additionally, uniformity of a parameter over a given region may imply uniformity from an average perspective.

Although first, second, and the like are used to describe various components, the components are not limited by these terms. These terms are used only to distinguish one component from another, and unless otherwise specifically stated, it is to be understood that a first component may also be a second component.

Throughout the specification, unless otherwise specifically stated, each element may be singular or plural.

When an arbitrary configuration is placed “on (or under)” a component or “above (or below)” a component, it can mean not only that the arbitrary configuration is placed in contact with the top (or bottom) of the component but also that other configurations can be interposed between the component and the arbitrary configuration placed on (or under) the component.

Further, when it is disclosed that a certain component is “connected,” “coupled,” or “linked” to another component, it should be understood that the components may be directly connected or linked to each other, but another component may be “interposed” between the components, or the components may be “connected,” “coupled,” or “linked” through another component. In addition, when a portion is “electrically coupled” to another part, this includes not only the case where it is “directly connected” but also the case where it is “connected” with another member or element interposed therebetween.

Whenever reference is made throughout the specification to “A and/or B,” this means A, B, or A and B, unless otherwise specified. That is, “and/or” includes all or any combination of the listed items. When “C to D” is described, this means C or more and D or less, unless otherwise specified.

In the present specification, “a combination thereof” may mean a mixture, a laminate, a compound, a copolymer, an alloy, a blend, and a reaction product of components.

The terms used in the present specification are intended to describe the embodiments of the present disclosure and are not intended to limit the present disclosure.

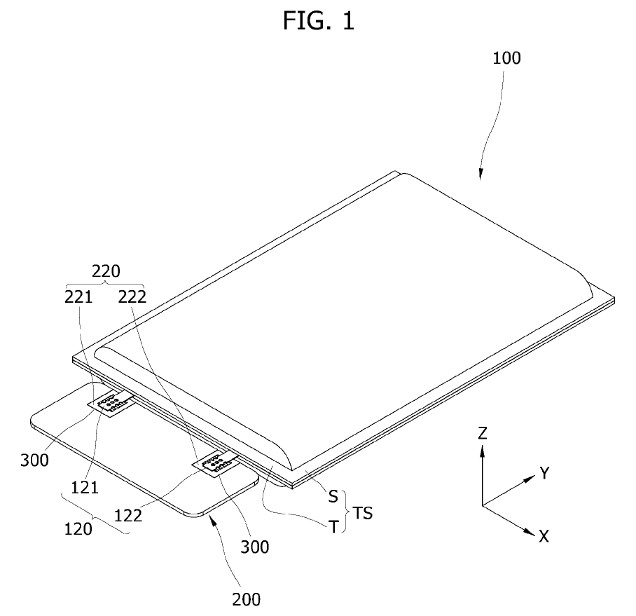

FIG. 1 is a perspective view schematically illustrating a configuration of a battery pack according to some embodiments of the present disclosure. Referring to FIG. 1, a battery pack 1 includes a battery 100 and a protection circuit module 200 electrically connected to the battery 100. In addition, the battery pack 1 further includes a connection part 300 connecting an electrode tab 120 of the battery 100 and a connection pad 220 of the protection circuit module 200 via a solder.

FIG. 1 illustrates a configuration where one battery 100 is electrically connected to the protection circuit module 200. However, unlike what is illustrated in FIG. 1, two or more batteries may be electrically connected to the protection circuit module 200. Alternatively, the battery pack 1 may include a plurality of protection circuit modules 200 and one or more batteries 100 may be electrically connected to each protection circuit module 200.

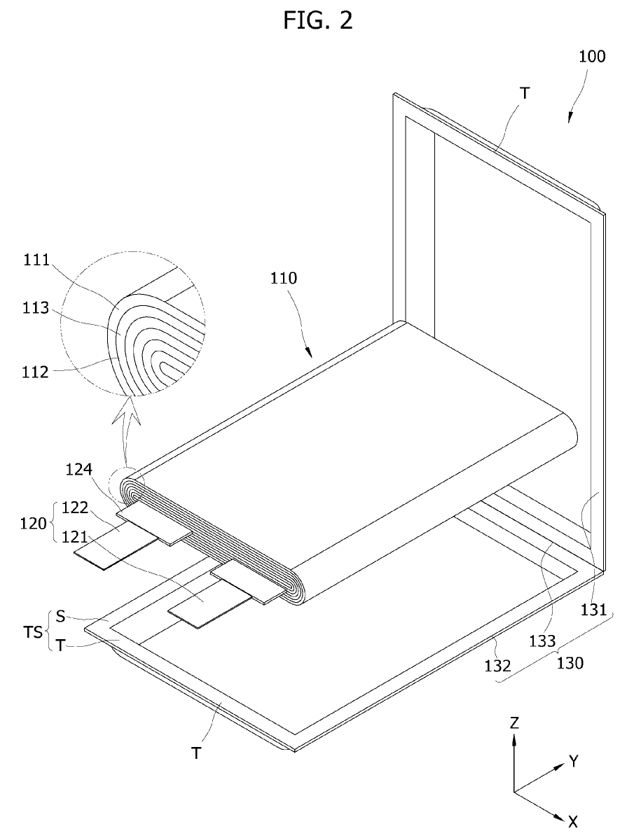

FIG. 2 is an exploded perspective view schematically illustrating a configuration of the battery 100 of FIG. 1 according to some embodiments of the present disclosure. Referring to FIG. 2, the battery 100 includes an electrode assembly 110, an electrode tab 120, and a case 130. The battery 2 according to the present embodiment may be a pouch-type battery in which the electrode assembly 110 is accommodated in the case 130 and which may charge and discharge a preset amount of power. However, embodiments of the present disclosure are not limited to the pouch-type battery and may include other types of secondary batteries such as a prismatic battery or a cylindrical battery.

The electrode assembly 110 may be formed by winding or stacking a laminate of a first electrode plate 111, a separator 113, and a second electrode plate 112, which are formed in a thin plate shape or film shape. When the electrode assembly 110 is a wound laminate, a winding axis may be parallel to a longitudinal direction of a case 130 (a Y-axis direction). In some embodiments, the electrode assembly 110 may be a stack type (not shown) instead of a winding type, or a Z stack electrode assembly (not shown) in which a positive electrode plate and a negative electrode plate are inserted on both sides of the separator 113 folded in a Z stack.

The first electrode plate 111 of the electrode assembly 110 may serve as a positive electrode and the second electrode plate 112 may serve as a negative electrode. In other embodiments, the first electrode plate 111 of the electrode assembly 110 may serve as a negative electrode and the second electrode plate 112 may serve as a positive electrode.

In some embodiments, the first electrode plate 111 functions as a positive electrode and may include a first uncoated portion formed by applying a first electrode active material such as graphite or carbon on a first electrode current collecting plate formed of a metal foil such as copper, a copper alloy, nickel, or a nickel alloy, and the first uncoated portion is a region where the first electrode active material is not applied.

The first electrode active material applied to the first electrode plate 111 may include a positive electrode active material. The positive electrode active material may be a compound capable of reversible intercalation and deintercalation of lithium (lithiated intercalation compound). More specifically, one or more of composite oxides of lithium and a metal selected from cobalt, manganese, nickel, and a combination thereof may be used.

The positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM), where 0<x<1, 0<y<1, 0<z<1, and x+y+z=1. In some embodiments, the positive electrode active material may include only one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM), and may include any two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, NCM).

The first uncoated portion may be a path for a current flow between the first electrode plate 111 and a first current collector. In some embodiments, the first uncoated portion may be formed by cutting the first electrode plate 111 so as to protrude to one side in advance when the first electrode plate 111 is manufactured and may protrude further to one side than the separator 113 without being separately cut after manufacture thereof.

The second electrode plate 112 may be formed by applying a second electrode active material such as a transition metal oxide on a second electrode current collecting plate formed of a metal foil such as aluminum or an aluminum alloy and may include a second uncoated portion, which is a region where the second electrode active material is not applied.

The second electrode active material applied to the second electrode plate 112 functioning as the negative electrode may include a negative electrode active material. The negative electrode active material may include a material capable of reversibly intercalating/deintercalating lithium ions, lithium metal, an alloy of lithium and a metal, a material capable of doping and dedoping lithium, or a transition metal oxide.

The material capable of reversibly intercalating/deintercalating lithium ions may be a carbon-based negative electrode active material, for example, crystalline carbon, amorphous carbon, or a combination thereof. The crystalline carbon may include graphite such as amorphous, plate-like, flaky, spherical, or fibrous natural graphite or artificial graphite, and the amorphous carbon may include soft carbon or hard carbon, mesophase pitch carbide, calcined coke, and the like.

An alloy of lithium and a metal may be selected from Na, K, Rb, Cs, Fr, Be, Mg, Ca, Sr, Si, Sb, Pb, In, Zn, Ba, Ra, Ge, Al, and Sn.

A Si-based negative electrode active material or Sn-based negative electrode active material may be used as the material capable of doping and dedoping lithium. The Si-based negative electrode active material may include silicon, a silicon-carbon composite, SiOₓ (0<x<2), a Si-Q alloy (where Q is selected from alkali metals, alkaline earth metals, group 13 elements, group 14 elements [excluding Si], group 15 elements, group 16 elements, transition metals, rare earth elements, and a combination thereof), or a combination thereof. The Sn-based negative electrode active material may include Sn, SnO₂, a Sn-based alloy, or a combination thereof.

The silicon-carbon composite may be a composite of silicon and amorphous carbon. According to some embodiments, the silicon-carbon composite may be in the form of silicon particles whose surface is coated with amorphous carbon. The silicon-carbon composite may include a secondary particle (a core) in which silicon primary particles are assembled and an amorphous carbon coating layer (a shell) located on the surface of the secondary particle. The amorphous carbon may also be located between the silicon primary particles so that the silicon primary particles may be coated with the amorphous carbon. The secondary particle may be dispersed in an amorphous carbon matrix.

The silicon-carbon composite may further include crystalline carbon. In some embodiments, the silicon-carbon composite may include a core, including crystalline carbon and silicon particles, and an amorphous carbon coating layer located on a surface of the core.

The Si-based negative electrode active material or the Sn-based negative electrode active material may be used in combination with the carbon-based negative electrode active material.

The second uncoated portion may be a path for a current flow between the second electrode plate 112 and a second current collector. In some embodiments, the second uncoated portion may be formed by cutting so as to protrude to the other side in advance when the second electrode plate 112 is manufactured and may protrude further to the other side than the separator 113 without separate cutting.

The electrode tab 120 may be connected to the electrode assembly 110. More specifically, the electrode tab 120 may be connected to an uncoated portion of the electrode assembly 110, or a portion of the uncoated portion of the electrode assembly 110 may protrude to the outside of the case 130 to function as the electrode tab 120. The electrode tab 120 may be electrically connected to the electrode assembly 110 and may be withdrawn from the case 130 accommodating the electrode assembly 110, and the electrode tab 120 may be withdrawn from a terrace portion T of the case 130.

The electrode tab 120 may include a first electrode tab 121 and a second electrode tab 122 having different polarities, and the first electrode tab 121 and the second electrode tab 122 may be electrically connected to the first electrode plate 111 and the second electrode plate 112, respectively. An insulating tape 124 may be attached to the electrode tab 120 to provide electrical insulation and sealing between the electrode tab 120 and the case 130.

According to some embodiments, the electrode tab 120 may have a shape of a thin plate having a predetermined width and length. The width (in parallel with an X-axis direction) of the electrode tab 120 may vary depending on a capacity or a structure of the battery 100. Also, the length (in parallel with a Y-axis direction) of the electrode tab 120 may be such that a length of the electrode tab 120 may face the connection pad 220 of the protection circuit module 200. The length and the width of the electrode tab 120 correspond to a length and a width of the connection pad 220.

The case 130 may be formed of a flexible exterior material such as a pouch. The case 130 may include an insulating layer (not illustrated) formed on both sides of a metal layer (not illustrated) of a thin plate such as aluminum and may be formed through a forming process such as drawing.

The case 130 may include a first exterior material 131 and a second exterior material 132 that are coupled to face each other with the electrode assembly 110 interposed therebetween. The case 130 may include a folding portion 133 that folds the first exterior material 131 and the second exterior material 132 to overlap each other and the electrode assembly 110 may be accommodated in the case 130 by folding the first exterior material 131 and the second exterior material 132 in a direction facing each other with the folding portion 133 as an axis.

As the first exterior material 131 and the second exterior material 132 are overlapped to face each other with the electrode assembly 110 interposed therebetween, a sealing portion TS for sealing an accommodation portion A may be formed together with the accommodation portion A in which the electrode assembly 110 is accommodated. The sealing portion TS may be formed along remaining side portions of the case 130 except for a side portion of the case 130 in which the folding portion 133 is formed. The case 130 may form a rectangular parallelepiped shape including a pair of short side portions facing each other and a pair of long side portions facing each other by combining the first exterior material 131 and the second exterior material 132. In addition, the sealing portion TS may be continuously formed along a short side portion and a pair of long side portions, but not a short side portion from which the folding portion 133 is formed.

The sealing portion TS may include the terrace portion T from which the electrode tab 120 electrically connected to the electrode assembly 110 is withdrawn, and a side sealing portion S that comes into contact with the terrace portion T and extends in a direction intersecting the terrace portion T. The terrace portion T may be formed on one short side portion of the case 130 and the side sealing portion S may be formed on the pair of long side portions of the case 130. The terrace portion T may seal the accommodation portion A while extending in a direction intersecting the electrode tab 120, and the side sealing portion S may seal the accommodation portion A while extending in a direction intersecting the terrace portion T.

The protection circuit module 200 may form a high current path, such as a charge/discharge current of the battery 100 or a low current path for status information of the battery 100. The protection circuit module 200 may obtain state information such as temperature, voltage, and current as state information of the battery 100. In addition, based on the obtained state information, the protection circuit module 200 may protect the battery 100 in response to an abnormal situation of the battery 100 and take appropriate protective measures in preparation for accidents such as explosion or ignition of the battery 100. The protection circuit module 200 may control a switch element formed on a charging/discharging path to stop charging/discharging of the battery 100.

To this end, the protection circuit module 200 may include a printed circuit board 210 and the connection pad 220 formed on the printed circuit board 210. The connection pad 220 may be electrically connected to the electrode tab 120 of the battery 100 and may be provided on an upper surface of the printed circuit board 210 to correspond to the number and position of the electrode tabs 120. In addition, although not illustrated in the drawing, the protection circuit module 200 further may include a plurality of electrical elements formed on the printed circuit board 210 and a plurality of wiring patterns electrically connecting the electrical elements. Additionally, the printed circuit board 210 may be provided with a terminal (not shown) for electrical connection with an external device.

The battery 100 forming an electrical connection with the protection circuit module 200 may be disposed near the protection circuit module 200. One or more batteries 100 forming an electrical connection with the protection circuit module 200 may be disposed near the protection circuit module 200. FIG. 1 illustrates a configuration where only one battery 100 is disposed near the protection circuit module 200, but FIG. 1 is merely exemplary of possible configurations.

When a plurality of batteries 100 are disposed near the protection circuit module 200, the batteries 100 may be disposed at adjacent positions so that the electrode tabs 120 extend parallel to each other. In FIG. 1, the protection circuit module 200 may have a sufficiently large size to be connected to each of the electrode tabs 120 of the plurality of batteries 100. In addition, at least two or more batteries 100 forming an electrical connection with the protection circuit module 200 may be disposed near the protection circuit module 200. For example, a plurality of batteries 100 may be disposed in parallel on one side of the protection circuit module 200 so that the electrode tabs 120 extend parallel to each other, or a plurality of batteries 100 may be disposed on both sides of the protection circuit module 200 so that the electrode tabs 120 face each other with the protection circuit module 200 interposed therebetween.

The protection circuit module 200 may be disposed to face the terrace portion T from which the electrode tabs 120 of the battery 100 are withdrawn. Accordingly, the battery 100 disposed to face the protection circuit module 200 may be electrically connected to the protection circuit module 200 via a minimum path through the electrode tab 120. In particular, the protection circuit module 200 may be disposed adjacent to the battery 100 such that an upper surface of the connection pad 220 provided on the upper surface of the printed circuit board 210 faces a lower surface of the electrode tab 120.

The connection part 300 electrically connects the battery 100 and the protection circuit module 200. More specifically, the connection part 300 has a configuration in which the electrode tab 120 of the battery 100 and the connection pad 220 of the protection circuit module 200 are disposed to face each other and are joined using solder. When the connection pad 220 is disposed on the upper surface of the printed circuit board 210, the connection part 300 may be arranged so that the lower surface of the electrode tab 120 and the upper surface of the connection pad 220 face each other and the facing portions may be joined via a solder.

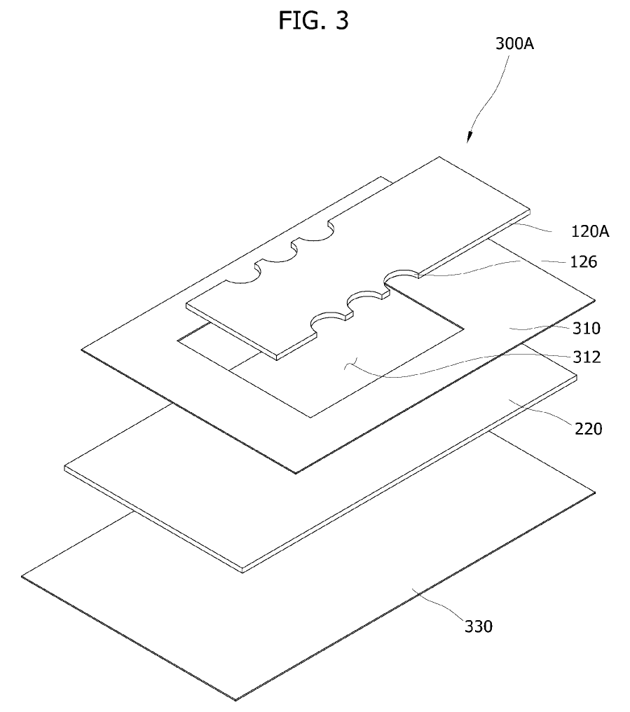

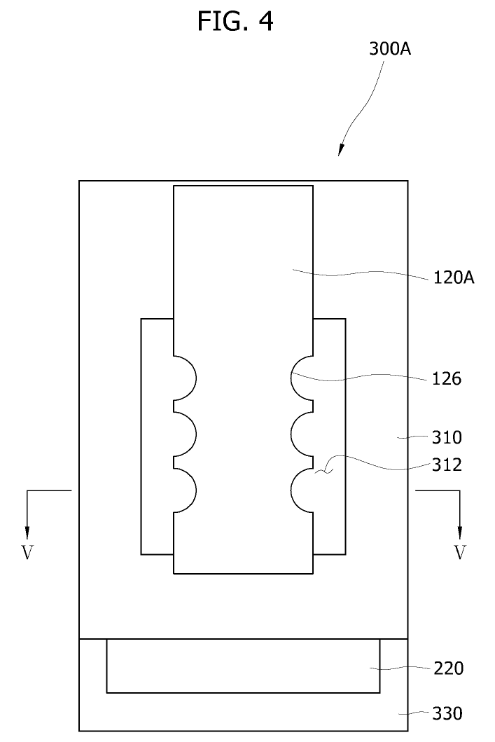

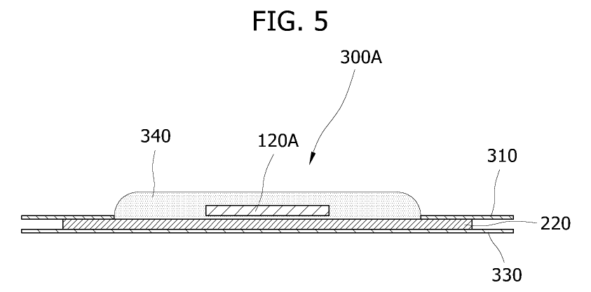

FIG. 3 is an exploded perspective view schematically illustrating a configuration of a connection part 300A of a battery pack according to some embodiments of the present disclosure. FIG. 4 is a plan view of the connection part 300A of FIG. 3 in a combined state according to some embodiments of the present disclosure. and FIG. 5 is a cross-sectional view along line V-V in FIG. 4 according to some embodiments of the present disclosure. In order to more clearly show the configuration of the connection part 300A, an illustration of soldering is omitted in FIGS. 3 and 4.

The connection part 300A may include an insulating sheet 330, and a connection pad 220 may be disposed on an upper surface of the insulating sheet 330. In some embodiments, the insulating sheet 330 may be disposed on an upper surface of the printed circuit board 210 of the protection circuit module 200 (FIG. 1), and the connection pad 220 may be disposed on an upper surface of the insulating sheet 330. The insulating sheet 330 may be larger in size (i.e., with respect to areas on the XY plane) than the connection pad 220 so as to sufficiently protect the lower printed circuit board 210 from heat generated in a soldering process.

The insulating sheet 330 serves to block the transfer of heat by molten lead to the lower printed circuit board 210 during the soldering process of an electrode tab 120A and the connection pad 220. Accordingly, even when the soldering process is performed, it is possible to prevent the wiring or electrical device provided on the printed circuit board 210 from being damaged by heat. For this purpose, the insulating sheet 330 may be any material with excellent insulating properties. For example, the insulating sheet 330 may be a mica sheet.

The connection pad 220 of the protection circuit module 200 may be disposed on the insulating sheet 330. A shape of the connection pad 220 is not particularly limited, but may be a rectangular plate shape. The connection pad 220 may be formed of a conductive metal such as copper (cu) or nickel (Ni). In addition, although not illustrated in the drawings, the connection pad 220 may be electrically connected to wiring of the protection circuit module 200.

An insulating film 310 may be disposed on the connection pad 220. An opening 312 having a predetermined size may be formed inside the insulating film 310. The opening 312 corresponds to an opening from which a part of the insulating film 310 is removed, and thus the upper surface of the connection pad 220 may be exposed.

A soldering region may be limited by the opening 312 of the insulating film 310. The molten lead generated during the soldering process may flow to the upper surface of the connection pad 220 through the opening 312, and the molten lead flowing inward may penetrate into an interface between the connection pad 220 and the electrode tab 120A. On the other hand, the molten lead flowing outward may be blocked by the insulating film 310 and may be hardened while stagnating only in the region limited by the opening 312.

The insulating film 310 may be formed of a polymer resin having insulating characteristics. For example, the insulating film 310 may be formed of polyimide, but the insulating film 310 is not limited thereto.

The electrode tab 120A of the battery 100 is disposed on the insulating film 310. More specifically, the electrode tab 120A is disposed on the insulating film 310 while at least partially covering the opening 312, so that a lower surface of the electrode tab 120A may face the upper surface of the connection pad 220 through the opening 312. The lower surface of the electrode tab 120 and the upper surface of the connection pad 220 do not completely come into close contact with each other due to the insulating film 310, and a slight gap may present at the interface between the electrode tab 120 and the connection pad 220. During the soldering process, the molten lead may penetrate into a space between the lower surface of the electrode tab 120A and the upper surface of the connection pad 220 through the gap at the interface between the electrode tab 120 and the connection pad 220.

The electrode tab 120A may be formed of a conductive metal. In addition, the electrode tab 120A may be formed of a material with excellent thermal conductivity so that the molten lead that has penetrated through a bottom surface of the electrode tab 120A may smoothly spread over the entire bottom surface. For example, the electrode tab 120A may be formed of copper or nickel, but the electrode tab 120A is not limited thereto.

Penetration grooves 126 with a predetermined pattern may be formed on both side surfaces of the electrode tab 120A to provide paths through which the molten lead may penetrate into the lower surface of the electrode tab 120A. The side surfaces of the electrode tab 120A may refer to both side surfaces parallel to the longitudinal direction (the Y-axis direction) in which the electrode tab 120A extends from the battery 100 and may refer to side surfaces facing in the width direction (the X-axis direction) intersecting the longitudinal direction.

Since the penetration grooves 126 are formed on both side surfaces of the electrode tab 120A, most of the molten lead supplied to the upper surface of the electrode tab 120A fills the opening 312 and covers the connection pad 220 and the electrode tab 120A, and at the same time, a part of the molten lead may flow along the penetration groove 126 by a capillary phenomenon to penetrate into the interface between the connection pad 220 and the electrode tab 120A. The penetration groove 126 may provide a space in which the molten lead penetrates from the side surface of the electrode tab 120A into the inside, compared to the side surface of the conventional electrode tab formed in a straight line.

The electrode tab 120A may have a predetermined thickness so that a capillary phenomenon may be induced by the penetration groove 126. In some embodiments, the electrode tab 120A may have a thickness of 0.15 mm or more. When the thickness of the electrode tab 120A is less than 0.15mm, a height of the penetration groove 126 is also less than 0.15mm, and, thus, the thickness may not be sufficient to cause a capillary phenomenon. There is no particular limitation on the upper limit of the thickness of the electrode tab 120A, but it is preferable to have a thickness of a predetermined value tailored to the specifications of the battery 100. In some embodiments, the thickness of the electrode tab 120A may be 0.2 mm or less.

There is no limitation on the shape or size of the penetration groove 126 as long as the molten lead may penetrate into the interface between the lower surface of the electrode tab 120A and the upper surface of the connection pad 220 during the soldering process.

The penetration groove 126 may have a semicircular shape, a predetermined curved shape (e.g., a half-oval shape), or a sawtooth shape. In addition, the size of the penetration groove 126 (i.e., the length in the X-axis or Y-axis direction) may be 0.5 mm or less, but the size of the penetration groove 126 is not limited thereto. In addition, the number of penetration grooves 126 formed on one side surface of the electrode tab 120A is not particularly limited.

The connection part 300A may include solder 340 that joins the connection pad 220 and the electrode tab 120. The solder 340 may fill the opening 312 of the insulating film 310. In addition, the solder 340 may cover at least the penetration groove 126 of the electrode tab 120 and a part of the solder 340 may penetrate into the contact interface between the connection pad 220 and the electrode tab 120A.

A part of the solder 340 may also penetrate through the contact interface between the connection pad 220 and the electrode tab 120A. Therefore, a bonding strength between the connection pad 220 and the electrode tab 120A may be improved. In addition, since the height of the solder 340 may be lowered compared to the related art, spatial efficiency of the connection part 300 may be improved.

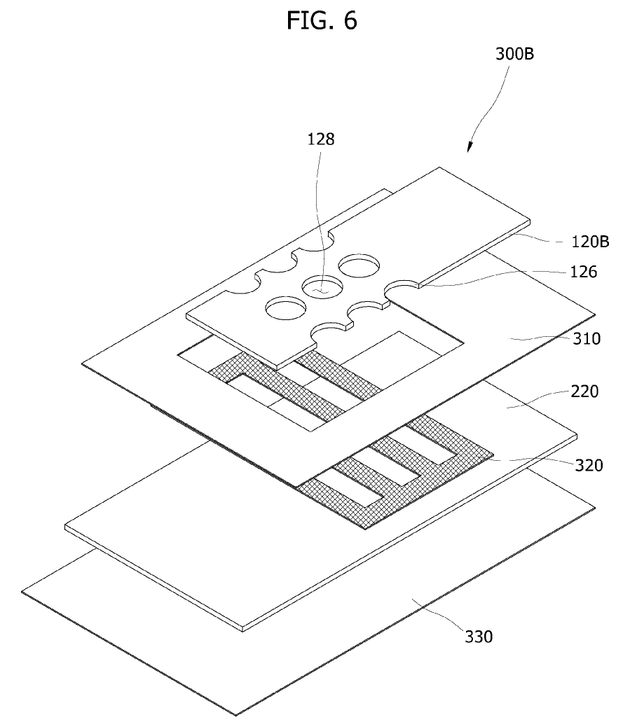

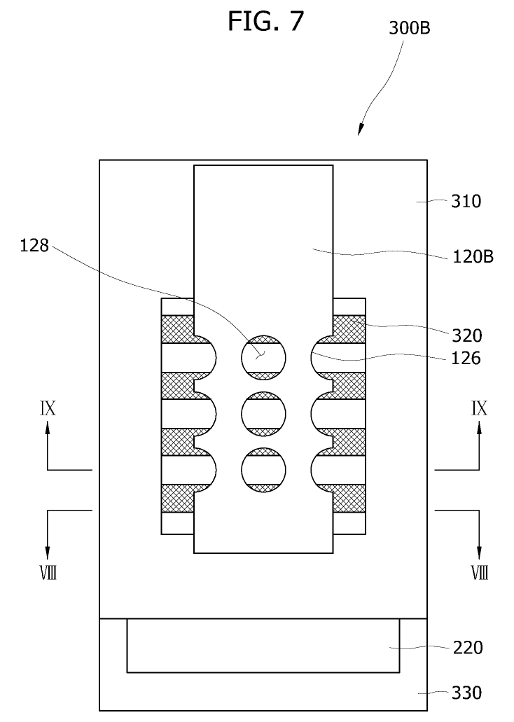

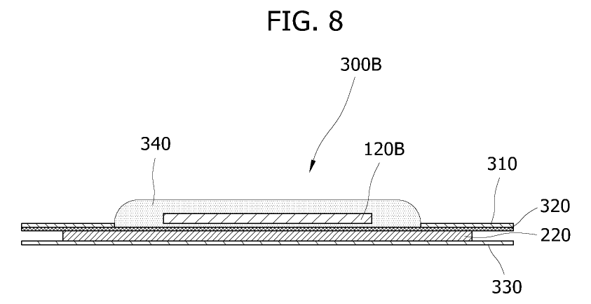

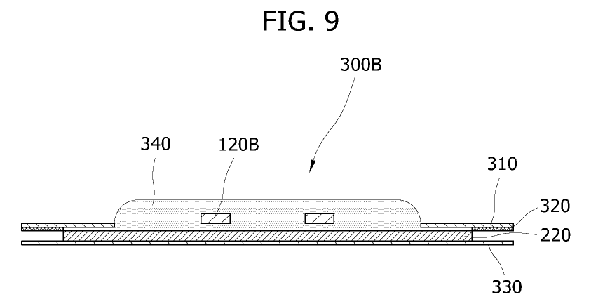

FIG. 6 is an exploded perspective view schematically illustrating a configuration of a connection part 300B according to some embodiments of the present disclosure. FIG. 7 is a plan view of the connection part 300B of FIG. 6 in a combined state according to some embodiments of the present disclosure. FIG. 8 is a cross-sectional view along line VIII-VIII in FIG. 7 according to some embodiments of the present disclosure. FIG. 9 is a cross-sectional view along line IX-IX in FIG. 7 according to some embodiments of the present disclosure. In order to more clearly show the configuration of the connection part 300B, an illustration of soldering is omitted in FIGS. 6 and 7.

The connection part 300B may include an insulating sheet 330 on which the connection pad 220 is disposed on an upper surface of the insulating sheet 330. In some embodiments, the insulating sheet 330 may be disposed on an upper surface of the printed circuit board 210 of the protection circuit module 200, and the connection pad 220 may be disposed on an upper surface of the insulating sheet 330. The insulating sheet 330 may be larger in size (i.e., with respect to areas on the XY plane) than the connection pad 220 so as to sufficiently protect the lower printed circuit board 210 from heat generated in a soldering process.

The insulating sheet 330 serves to block the transfer of heat by molten lead to the lower printed circuit board 210 during the soldering process of the electrode tab 120 and the connection pad 220. Accordingly, even when the soldering process is performed, it is possible to prevent the wiring or electrical device provided on the printed circuit board 210 from being damaged by heat. For this purpose, the insulating sheet 330 may be any material with excellent insulating properties. For example, the insulating sheet 330 may be a mica sheet.

The connection pad 220 of the protection circuit module 200 may be disposed on the insulating sheet 330. The shape of the connection pad 220 is not particularly limited, but may be a rectangular plate shape. The connection pad 220 may be formed of a conductive metal such as copper (cu) or nickel (Ni). In addition, although not illustrated in the drawing, the connection pad 220 may be electrically connected to wiring of the protection circuit module 200.

A metal pattern 320 may be disposed on the connection pad 220. The metal pattern 320 may be for providing a space in which molten lead may penetrate into a lower part of the electrode tab 120B while maintaining an electrical connection between the connection pad 220 and the electrode tab 120B. The metal pattern 320 may be formed of a conductive metal so that the lower connection pad 220 and the upper electrode tab 120B may maintain an electrical connection. In addition, since a plurality of metal patterns 320 may be spaced apart, molten lead may penetrate into the lower part of the electrode tab 120B while filling an empty space between the metal patterns 320.

Accordingly, some solder 340 may penetrate into the space between the metal patterns as well as the contact interface between the connection pad 220 and the electrode tab 120B. Therefore, according to the connection part 300B, the bonding strength between the connection pad 220 and the electrode tab 120B may be further improved compared to the connection part 300A described with reference to FIGS. 3 to 5. In addition, since the height of the solder 340 may be lowered compared to the related art, spatial efficiency of the connection part 300B may also be improved.

To this end, the metal pattern 320 may be formed of a same metal material as the connection pad 220. The metal pattern 320 may be formed of a metal material having excellent electrical conductivity and thermal conductivity, such as copper or nickel.

In some embodiments, the metal pattern 320 may have a line-type shape extending in the width direction (the X-axis direction) of the electrode tab 120B. In some embodiments, the line-type metal pattern 320 may be offset from the penetration groove 126 and a penetration hole 128 of the electrode tab 120B. Accordingly, the molten lead flows down through the penetration groove 126 and the penetration hole 128 to better penetrate into the empty space between the metal patterns 320 and the interface between the connection pad 220 and the electrode tab 120B. When the electrode tab 120B further includes the penetration hole 128, the metal pattern 320 may also be offset from the penetration hole 128.

An insulating film 310 may be disposed on the metal pattern 320. An opening 312 having a predetermined size may be formed inside the insulating film 310. The opening 312 corresponds to an opening from which a part of the insulating film 310 is removed, and, thus, the upper surface of the connection pad 220 may be exposed by empty spaces between metal portions of the metal pattern 320.

The soldering region may be limited by the opening 312 of the insulating film 310. More specifically, the molten lead generated during the soldering process flows through the upper surface of the metal pattern, and through the upper surface of the connection pad 220 between the metal patterns, via the opening 312, and the molten lead flowing inward may penetrate an interface between the metal pattern and connection pad 220 and the electrode tab 120A. On the other hand, the molten lead flowing outward may be blocked by the insulating film 310 and may be hardened while stagnating only in the region limited by the opening 312.

The insulating film 310 may be formed of a polymer resin having insulating characteristics. For example, the insulating film 310 may be formed of polyimide, but the insulating film 310 is not limited thereto.

The electrode tab 120B of the battery 100 may be disposed on the insulating film 310. More specifically, the electrode tab 120B is disposed on the insulating film 310 while at least partially covering the opening 312, so that the lower surface of the electrode tab 120B may face the upper surface of the connection pad 220 through the opening 312. In some embodiments, the lower surface of the electrode tab 120B and the upper surface of the connection pad 220 do not completely come into close contact with each other due to the insulating film 310, and a slight gap may be present at the interface between the electrode tab 120B and the connection pad 220. During the soldering process, the molten lead may penetrate into a space between the lower surface of the electrode tab 120B and the upper surfaces of the metal pattern 320 and the connection pad 220 through the gap at the interface between the electrode tab 120B and the connection pad 220.

The electrode tab 120B may be formed of a conductive metal. In addition, the electrode tab 120B may be formed of a material with excellent thermal conductivity so that the molten lead that has penetrated through a bottom surface of the electrode tab 120B may smoothly spread over the entire bottom surface. For example, the electrode tab 120B may be formed of copper or nickel, but the electrode tab 120B is not limited thereto.

The penetration grooves 126 with a predetermined pattern may be formed on both side surfaces of the electrode tab 120B to provide paths through which the molten lead may penetrate into the lower surface of the electrode tab 120B. The side surfaces of the electrode tab 120B may refer to both side surfaces parallel to the longitudinal direction (the Y-axis direction) in which the electrode tab 120B extends from the battery 100 and may refer to side surfaces facing in the width direction (the X-axis direction) intersecting the longitudinal direction.

In some embodiments, a penetration hole 128 with a predetermined pattern may be further formed in the central part of the electrode tab 120B to provide another path through which the molten lead may penetrate into the lower surface of the electrode tab 120B. In some embodiments, the penetration hole 128 performs essentially the same function as the penetration groove 126, and, when the width of the electrode tab 120B is relatively large, the penetration hole 128 allows the molten lead penetrating through the penetration groove 126 to penetrate to a location that cannot reach, such as, for example, a central part of the lower surface of the electrode tab 120B.

Since the penetration grooves 126 are formed on both side surfaces of the electrode tab 120B and penetration holes 128 are formed in the central portion of the electrode tab 120B, most of the molten lead supplied to the upper surface of the electrode tab 120B may fill the opening 312 and may cover the connection pad 220 and the electrode tab 120B, and, at the same time, a part of the molten lead may flow along the penetration groove 126 and the penetration hole 128 by a capillary phenomenon to penetrate into the interface between the connection pad 220 and the electrode tab 120B. Compared to the conventional side surface of the electrode tab formed in a straight line, the penetration groove 126 may provide a space for molten lead to penetrate from the side of the electrode tab 120B into the inside thereof, and the penetration hole 128 may provide an additional space for molten lead to penetrate a location where the molten lead penetrating through the penetration groove 126 cannot reach.

The electrode tab 120B may have a predetermined thickness so that a capillary phenomenon may be induced by the penetration groove 126 and the penetration hole 128. In some embodiments, the electrode tab 120B may have a thickness of 0.15 mm or more. When the thickness of the electrode tab 120B is less than 0.15mm, heights of the penetration groove 126 and the penetration hole 128 are also less than 0.15mm, and, thus, the thickness may not be sufficient to cause a capillary phenomenon. There is no particular limitation on the upper limit of the thickness of the electrode tab 120B, but it is preferable to have a thickness of a predetermined value tailored to the specifications of the battery 100. In some embodiments, the thickness of the electrode tab 120B may be 0.2 mm or less.

There is no limitation on the shape or size of the penetration groove 126 and the penetration hole 128 as long as the molten lead can penetrate into the interface between the lower surface of the electrode tab 120Band the upper surface of the connection pad 220 during the soldering process.

The penetration groove 126 may have a semicircular shape, a predetermined curved shape (e.g., a half-oval shape), or a sawtooth shape, and the penetration hole 128 may have a circular shape, an oval shape, or a polygonal shape. In addition, a size of the penetration groove 126 or the penetration hole 128 (i.e., lengths in the X-axis or Y-axis direction) may be 0.5 mm or less, but the size of the penetration groove 126 or the penetration hole 128 is not limited thereto. In addition, there is no particular limitation on the number of penetration grooves 126 formed on one side surface of the electrode tab 120B or the number of penetration holes 128 formed inside the electrode tab 120B.

The connection part 300 may include the solder 340 that joins the connection pad 220 and the electrode tab 120B. The solder 340 may fill the opening 312 of the insulating film 310. Also, the solder 340 may cover at least the penetration groove 126 and penetration hole 128 of the electrode tab 120B, and a part of the solder 340 may penetrate into the contact interface between the metal pattern 320 and the electrode tab 120B and the space between the connection pad 220 and the electrode tab 120B.

As described above, according to the connection part 300B, a part of the solder 340 may penetrate through not only the contact interface between the metal pattern 320 and the electrode tab 120Band/or the space between the connection pad 220 and the electrode tab 120B. Therefore, the bonding strength between the connection pad 220 and the electrode tab 120B may be improved. In addition, since the height of the solder 340 may be lowered compared to the related art, spatial efficiency of the connection part 300B may be improved.

According to the present disclosure, by arranging and soldering electrode tabs patterned with penetration grooves and/or penetration holes on a connection pad of a protection circuit module, lead flows through the penetration groove and/or the penetration hole to improve bonding strength between the connection pad and the electrode tab and to lower a height of solder, thereby saving space occupied by a connection part.

However, the effects obtained through the present invention are not limited to the above-described effects, and other technical effects that are not mentioned herein will be clearly understood by those skilled in the art from aspects of the invention described and/or shown in this detailed description, the drawings, and/or the claims below.

Although the present disclosure has been described by various embodiments and drawings, the present invention is not limited thereto, and various modifications and variations may be made by those skilled in the art.

What is claimed is:

1. A battery pack comprising:
a battery including an electrode tab;
a protection circuit module electrically connected to the battery, the protection circuit including a connection pad; and
a connection part where the electrode tab and the connection pad of the protection circuit module are connected via a solder,
wherein an insulating film in the connection part includes an opening exposing a part of the connection pad to the electrode tab, with the insulating film being bonded to an upper surface of the connection pad, and
wherein the electrode tab is disposed on an upper side of the insulating film and is joined to the connection pad via the solder, which extends through the opening and contacts the connection pad and the electrode tab.

2. The battery pack of claim 1, wherein a part of the solder extends through a contact interface between the electrode tab and the connection pad.

3. The battery pack of claim 2, wherein a penetration groove is formed on a side surface of the electrode tab, and wherein the solder covers the penetration groove.

4. The battery pack of claim 3, wherein the penetration groove has a semicircular shape.

5. The battery pack of claim 3, wherein a penetration hole is formed through the electrode tab, and wherein the solder covers the penetration hole.

6. The battery pack of claim 5, wherein the penetration hole has a circular shape.

7. The battery pack of claim 3, wherein the connection part further includes a metal pattern between the connection pad and the insulating film, the connection pad being at least a partially exposed via empty spaces between metal portions of the metal pattern, and wherein the electrode tab is joined with the connection pad via the solder while the insulating film and the connection pad are in contact with the metal pattern.

8. The battery pack of claim 7, wherein the metal pattern is a line-shaped pattern offset from the penetration groove and extending in a width direction of the electrode tab.

9. The battery pack of claim 7, wherein the metal pattern is formed of a same material as the connection pad.

10. The battery pack of claim 1, wherein the connection part further includes an insulating sheet disposed under the connection pad.

11. The battery pack of claim 10, wherein the insulating sheet is a mica sheet.

12. The battery pack of claim 1, wherein the connection pad is formed by a material including copper or nickel.

13. The battery pack of claim 1, wherein the insulating film is formed by a material including polyimide.

14. A battery pack comprising:
a battery having an electrode tab protruding outside of a case;
a protection circuit module including a connection pad, the protection circuit module being electrically connected to the battery by the connection pad joined to the electrode tab; and
an insulating film disposed between the electrode tab and the connection pad, the insulating film including an opening exposing a part of the connection pad to the electrode tab,
wherein a solder extends through the opening and contacts the electrode tab and the connection pad so that the solder joins the electrode tab and the connection pad.

15. The battery pack of claim 14, wherein a part of the solder extends through a contact interface between the electrode tab and the connection pad.

16. The battery pack of claim 15, wherein a penetration groove is formed on a side surface of the electrode tab, and wherein the solder covers the penetration groove.

17. The battery pack of claim 15, wherein a penetration hole is formed through the electrode tab, and wherein the solder covers the penetration hole.

18. The battery pack of claim 14, further comprising a metal pattern between the connection pad and the insulating film, the connection pad being at least partially exposed via the opening, and wherein the electrode tab is joined with the connection pad via the solder while the insulating film and the connection pad are in contact with the metal pattern.

19. The battery pack of claim 18, wherein a penetration groove is formed on a side surface of the electrode tab, and wherein the metal pattern is a line-shaped pattern offset from the penetration groove and extending in a width direction of the electrode tab.

20. The battery pack of claim 14, further comprising an insulating sheet disposed under the connection pad.
